(19) United States
(12) Patent Application Publication
(10) Pub. No.: US 2026/0236935 A1
(43) Pub. Date: Aug. 13, 2026

(54) USER TERMINAL DEVICE FOR CALCULATING CARBON EMISSIONS BASED ON USAGE TIME AND METHOD OF CONTROLLING THE SAME

(71) Applicants: Hyukjin AHN, Seoul (KR); Jiwan KIM, Bucheon (KR)

(72) Inventors: Hyukjin AHN, Seoul (KR); Jiwan KIM, Bucheon (KR)

(21) Appl. No.: 18/851,226

(22) PCT Filed: Sep. 13, 2024
(86) PCT No.: PCT/KR2024/014074

§ 371 Date: Sep. 26, 2024

(30) Foreign Application Priority Data
Sep. 13, 2024 (KR) 10-2024-0126048

(51) Int. Cl. G06Q 30/018

(52) U.S. Cl. CPC G06Q 30/018

(57) ABSTRACT

The present disclosure provides a user terminal device for calculating carbon emissions based on usage time, and a method of controlling the same. A method of controlling a user terminal device according to an embodiment of the present disclosure includes: identifying the usage time of the user terminal device; calculating the carbon emissions of the user terminal device corresponding to the identified usage time during a preset cycle based on the identified usage time; and displaying a user interface (UI) displaying the calculated carbon emissions through a display.

### TECHNICAL FIELD

The present disclosure relates to a user terminal device for calculating carbon emissions based on usage time and a method of controlling the same. More specifically, the present disclosure relates to a user terminal device that calculates carbon emissions for each application running on the user terminal device and prompts a user to reduce carbon emissions, and a method of controlling the same.

### BACKGROUND ART

Recently, the increase in carbon emissions around the world has emerged as a serious social problem. With the progress of industrial development, the concentration of greenhouse gases in the atmosphere, especially carbon dioxide, has continued to increase, and the rapid increase in carbon dioxide has caused various social and environmental problems such as global warming, ecosystem destruction, sea level rise, and extreme climate change. In order to deal with these problems, the governments and companies of individual countries are continuously making efforts to reduce carbon emissions, and various regulations and policies are being introduced.

Among them, the cap-and-trade system is a representative system. This system is a market-oriented mechanism that sets a specific carbon emission limit for each company or country and compels the purchase of additional permits when it is exceeded. Through this system, companies are seeking technological development and managing methods to reduce carbon emissions, and are strengthening carbon reduction efforts to reduce costs. The cap-and-trade system acts as an important factor in increasing environmental competitiveness between companies and is being established as part of the response to climate change.

Recently, as the use of personal electronic devices such as smartphones has increased rapidly, interest in the environmental impact of these devices has increased. Smartphones emit a significant amount of carbon during their manufacturing, distribution, use, and disposal processes, and in particular, the power consumed when smartphones are used and the energy consumption of data centers supporting smartphones are major sources of carbon emissions. In this context, there is emerging a need for the development of technology for measuring and managing carbon emissions related to the use of a smartphone.

### DISCLOSURE

### Technical Problem

The present disclosure has been conceived in response to the foregoing background technology, and is intended to provide a user terminal device for calculating carbon emissions based on usage time and a method of controlling the same.

However, the objects to be accomplished by the present disclosure are not limited to the object mentioned above, and other objects not mentioned may be clearly understood based on the following description.

### Technical Solution

According to an aspect of the present invention, there is provided a method of controlling a user terminal device for calculating carbon emissions based on usage time, the method including: identifying the usage time of the user terminal device; calculating the carbon emissions of the user terminal device corresponding to the identified usage time during a preset cycle based on the identified usage time; and displaying a user interface (UI) displaying the calculated carbon emissions through a display.

The method may further include: identifying the calculated carbon emissions compared to first reference carbon emissions applied during the preset cycle; and, when the calculated carbon emissions compared to the first reference carbon emissions are smaller than a reference value, calculating and providing a reward corresponding to the calculated carbon emissions.

The method may further include, when the calculated carbon emissions compared to the first reference carbon emissions are equal to or larger than the reference value, applying second reference carbon emissions smaller than the first reference carbon emissions to a subsequent cycle.

Identifying may include identifying the usage time of each of a plurality of applications installed on the user terminal device during the preset cycle, and calculating may include calculating the total carbon emissions of the user terminal device and carbon emissions attributable to the use of each of the plurality of applications during the preset cycle based on the identified usage time of each application.

The method may further include: selecting a management application from among the plurality of applications based on the usage time of each of the plurality of applications; and managing the use of the selected management application during a subsequent cycle.

Calculating the total carbon emissions and the carbon emissions attributable to the use of each application may include calculating the carbon emissions attributable to the use of each application by applying a weight, calculated according to the environment of a data center corresponding to each application, to the usage time of each application.

The method may further include generating challenge content for reducing the carbon emissions of the user terminal device and sharing the generated challenge content with a plurality of other users through a communication interface, and displaying may include identifying the rankings of the user and the plurality of other users, who share the challenge content, for carbon emissions in the preset cycle based on the calculated carbon emissions and displaying the identified rankings through the display.

The method may further include, when the challenge content ends, calculating a reward based on a final ranking for the carbon emissions of the user.

The method may further include: generating challenge content for reducing the carbon emissions of the user terminal device; sharing the generated challenge content with a plurality of other users through a communication interface; identifying the carbon emissions of the plurality of users who share the generated challenge content, and setting reference carbon emissions for the plurality of users; selecting a user of interest from among the plurality of users based on the reference carbon emissions; and determining reference carbon emissions for the plurality of users for a subsequent cycle based on the carbon emissions of the plurality of users, and applying reference carbon emissions different from the determined reference carbon emissions to the selected user of interest.

According to another aspect of the present invention, there is provided a user terminal device for calculating carbon emissions based on usage time, the user terminal device including: a display; memory configured to store at least one instruction; and at least one processor configured to, by executing the at least one instruction, identify the usage time of the user terminal device during a preset cycle, calculate the carbon emissions of the user terminal device during the preset cycle based on the identified usage time, and display a user interface (UI) corresponding to the calculated carbon emissions through the display.

According to still another aspect of the present invention, there is provided a computer program stored on a computer-readable storage medium, the computer program, when executed on at least one processor, causing the processor to perform a method of controlling a user terminal device for calculating carbon emissions based on usage time, wherein the method includes: identifying the usage time of the user terminal device; calculating the carbon emissions of the user terminal device corresponding to the identified usage time during a preset cycle based on the identified usage time; and displaying a user interface (UI) displaying the calculated carbon emissions through a display.

### Advantageous Effects

Through the user terminal device for calculating carbon emissions based on usage time according to an embodiment of the present disclosure and the method of controlling the same, the amount of carbon generated by the use of the user terminal device may be reduced. In particular, by monitoring the carbon emissions of the user terminal device, the carbon emissions may be reduced by prompting a user to appropriately adjust the use of the user terminal device.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is an exemplary diagram showing a user terminal device for calculating carbon emissions based on usage time according to an embodiment of the present disclosure;

FIG. 2 is a block diagram of a user terminal device according to an embodiment of the present disclosure;

FIG. 3 is a flowchart schematically showing a method of controlling a user terminal device for calculating carbon emissions based on usage time according to an embodiment of the present disclosure;

FIG. 4 is a flowchart showing a method of calculating carbon emissions compared to reference carbon emissions and then calculating a reward according to an embodiment of the present disclosure;

FIG. 5 is an exemplary diagram showing a method of setting reference carbon emissions according to an embodiment of the present disclosure and a method of calculating a reward based on carbon emission amounts compared to the reference carbon emissions;

FIG. 6 is an exemplary diagram showing a method of calculating carbon emissions for each of a plurality of applications according to an embodiment of the present disclosure;

FIG. 7 is an exemplary diagram of challenge content for reducing carbon emissions according to an embodiment of the present disclosure; and

FIG. 8 is a block diagram showing the detailed configuration of a user terminal device according to an embodiment of the present disclosure.

### MODE FOR INVENTION

Embodiments of the present disclosure will be described in detail below with reference to the accompanying drawings so that those having ordinary skill in the art of the present disclosure (hereinafter referred to as those skilled in the art) can easily implement the present disclosure. The embodiments presented in the present disclosure are provided to enable those skilled in the art to use or practice the content of the present disclosure. Accordingly, various modifications to embodiments of the present disclosure will be apparent to those skilled in the art. That is, the present disclosure may be implemented in various different forms and is not limited to the following embodiments.

The same or similar reference numerals denote the same or similar components throughout the specification of the present disclosure. Additionally, in order to clearly describe the present disclosure, reference numerals for parts that are not related to the description of the present disclosure may be omitted in the drawings.

The term “or” used herein is intended not to mean an exclusive “or” but to mean an inclusive “or.” That is, unless otherwise specified herein or the meaning is not clear from the context, the clause “X uses A or B” should be understood to mean one of the natural inclusive substitutions. For example, unless otherwise specified herein or the meaning is not clear from the context, the clause “X uses A or B” may be interpreted as any one of a case where X uses A, a case where X uses B, and a case where X uses both A and B.

The term “and/or” used herein should be understood to refer to and include all possible combinations of one or more of listed related concepts.

The terms “include” and/or “including” used herein should be understood to mean that specific features and/or components are present. However, the terms “include” and/or “including” should be understood as not excluding the presence or addition of one or more other features, one or more other components, and/or combinations thereof.

Unless otherwise specified herein or unless the context clearly indicates a singular form, the singular form should generally be construed to include “one or more.”

The term “N-th (N is a natural number)” used herein can be understood as an expression used to distinguish the components of the present disclosure according to a predetermined criterion such as a functional perspective, a structural perspective, or the convenience of description. For example, in the present disclosure, components performing different functional roles may be distinguished as a first component or a second component. However, components that are substantially the same within the technical spirit of the present disclosure but should be distinguished for the convenience of description may also be distinguished as a first component or a second component.

The term “acquisition” used herein can be understood to mean not only receiving data over a wired/wireless communication network connecting with an external device or a system, but also generating data in an on-device form.

Meanwhile, the term “module” or “unit” used herein may be understood as a term referring to an independent functional unit processing computing resources, such as a computer-related entity, firmware, software or part thereof, hardware or part thereof, or a combination of software and hardware. In this case, the “module” or “unit” may be a unit composed of a single component, or may be a unit expressed as a combination or set of multiple components. For example, in the narrow sense, the term “module” or “unit” may refer to a hardware component or set of components of a computing device, an application program performing a specific function of software, a procedure implemented through the execution of software, a set of instructions for the execution of a program, or the like. Additionally, in the broad sense, the term “module” or “unit” may refer to a computing device itself constituting part of a system, an application running on the computing device, or the like. However, the above-described concepts are only examples, and the concept of “module” or “unit” may be defined in various manners within a range understandable to those skilled in the art based on the content of the present disclosure.

The term “model” used herein may be understood as a system implemented using mathematical concepts and language to solve a specific problem, a set of software units intended to solve a specific problem, or an abstract model for a process intended to solve a specific problem. For example, a neural network “model” may refer to an overall system implemented as a neural network that is provided with problem-solving capabilities through training. In this case, the neural network may be provided with problem-solving capabilities by optimizing parameters connecting nodes or neurons through training. The neural network “model” may include a single neural network, or a neural network set in which multiple neural networks are combined together. “Data” used herein may include “images,” signals, etc. The term “image” used herein may refer to multidimensional data composed of discrete image elements. In other words, “image” may be understood as a term referring to a digital representation of an object that can be seen by the human eye. For example, “image” may refer to multidimensional data composed of elements corresponding to pixels in a two-dimensional image. “Image” may refer to multidimensional data composed of elements corresponding to voxels in a three-dimensional image.

The foregoing description of the terms is intended to help understand the present disclosure. Therefore, it should be noted that when the above terms are not explicitly stated as matters limiting the content of the present disclosure, they are not used to limit the content and technical spirit of the present disclosure.

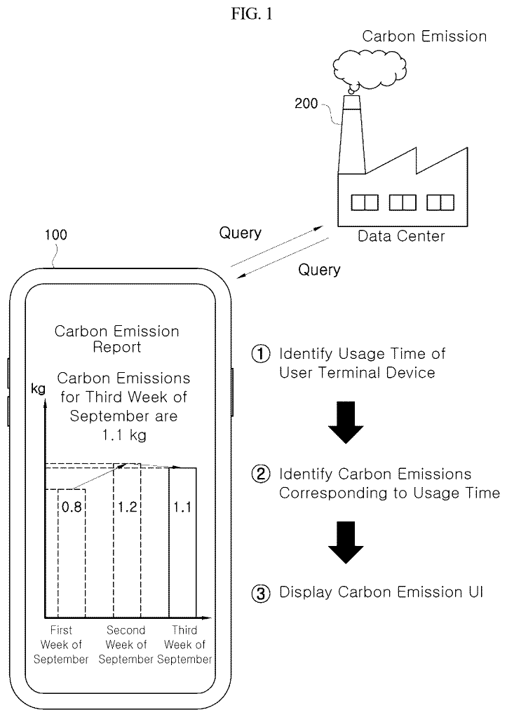

FIG. 1 is an exemplary diagram showing a user terminal device 100 for calculating carbon emissions based on usage time according to an embodiment of the present disclosure.

Referring to FIG. 1, the user terminal device 100 according to an embodiment of the present disclosure may be a hardware device or a part of a hardware device that performs the comprehensive processing and calculation of data, or may be a software-based computing environment that is connected over a communication network. For example, the user terminal device 100 may be a server that performs an intensive data processing function and shares resources, or may be a client that shares resources through interaction with a server. Furthermore, the user terminal device 100 may be a cloud system in which pluralities of servers and clients comprehensively process data while interacting with each other. Since the foregoing description is only one example related to the type of user terminal device 100, the type of user terminal device 100 may be configured in various forms within a scope that can be understood by those skilled in the art based on the contents of the present disclosure.

As an example, the user terminal device 100 may be implemented as various electronic devices such as a desktop, a laptop, a smartphone, a server, etc. Hereinafter, for the convenience of description of the present disclosure, the user terminal device 100 will be described on the assumption that it is a smartphone.

According to an embodiment of the present disclosure, the user terminal device 100 may calculate the carbon emissions of the user terminal device 100 based on the usage time of the user terminal device 100 of a user.

In this case, the carbon emissions may be the amount of carbon that is generated when the user uses the user terminal device 100.

The carbon emissions of the user terminal device 100 may be calculated based on the amount of carbon that is emitted from the data center 200 related to the use of the user terminal device 100 while the user uses the user terminal device 100. For example, while the user terminal device 100 executes a specific application (or a specific program) installed on the user terminal device 100, carbon may be emitted from the data center 200 (or server) of the specific application. In particular, while executing a specific application, the user terminal device 100 repeatedly transmits queries containing various types of request information to the data center 200 of the specific application. Then, the data center 200 may emit carbon by performing tasks based on the received queries and, at the same time, consuming power for this purpose. Accordingly, the user terminal device 100 may estimate and identify the amount of carbon, emitted from the data center 200, as the carbon emissions of the user terminal device 100.

To this end, according to an embodiment of the present disclosure, the user terminal device 100 may identify the carbon emissions based on the usage time of the user terminal device 100 of the user. That is, the user terminal device 100 may identify carbon emissions corresponding to usage time by determining that carbon emissions have occurred in the data center 200 that operates in conjunction with the user terminal device 100 while the user uses the user terminal device 100.

In particular, according to an embodiment of the present disclosure, the user terminal device 100 may calculate carbon emissions for each application executed by the user. That is, the user terminal device 100 may identify the usage times of a plurality of applications executed by the user and then calculate carbon emissions for each of the applications based on the identified usage time of each application.

Meanwhile, even when different applications are used during the same time, the carbon emissions of the data center 200 may be different from each other. More specifically, while each of the applications is being executed, the user terminal device 100 communicates with the data center 200 of each application. In this case, the amount of carbon emitted from each data center 200 may vary depending on the environment of the data center 200. The environment of the data center 200 may include a data transmission path based on data routing, the power supply method of the data center 200, the efficiency of the cooling system of the data center 200, the operation method of the data center 200, and/or the like. Accordingly, the user terminal device 100 may apply a weight to take into consideration the environment of the data center 200 of each of the applications when calculating carbon emissions for each application.

Meanwhile, referring to FIG. 1, the user terminal device 100 may periodically determine the usage time of the user terminal device 100 of the user, may calculate carbon emissions, and may display content including a user interface (UI) that can monitor calculated carbon emissions. In particular, the user terminal device 100 may output information prompting the user to reduce carbon emissions to the user when carbon emissions are excessive. Such information may be output in various forms such as text, image, and sound.

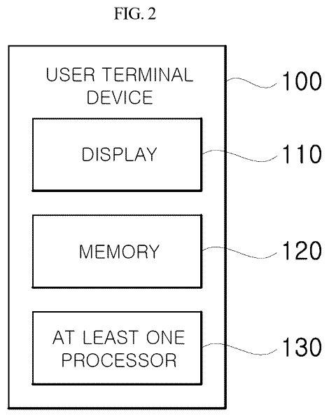

An embodiment of the present disclosure related to this will be described in detail below with reference to FIGS. 2 to 7. The foregoing description of the present disclosure may be applied below in the same manner.

FIG. 2 is a block diagram of a user terminal device 100 according to an embodiment of the present disclosure.

Referring to FIG. 2, the user terminal device 100 includes a display 110, memory 120, and at least one processor 130 (hereinafter referred to as the “processor 130”). However, FIG. 2 shows only an example, and the user terminal device 100 may include other components for implementing a computing environment. Alternatively, only some of the disclosed components may be included in the user terminal device 100.

The display 110 may display various images 110. In this case, the images include both still images and moving images. In particular, the display 110 may display information about carbon emissions. For example, the display 110 may display a UI and content related to carbon emissions calculated periodically. In this case, the UI related to carbon emissions may include a graphics object representative of carbon emissions calculated for each period.

The display 110 may be implemented as displays having various forms such as a liquid crystal display (LCD) panel, a light-emitting diode (LED) display, an organic light-emitting diode (OLED) display, a liquid crystal on silicon (LCoS) display, a digital light processing (DLP) display, etc. Furthermore, the display 110 may also include a drive circuit, which may be implemented in a form such as an a-si TFT, an low temperature poly silicon (LTPS) TFT, an organic TFT (OTFT), and/or the like, a backlight unit, etc.

Meanwhile, the display 110 may be implemented as a touch screen through the combination with a touch panel. In this case, the display 110 may perform not only an output interface function for outputting images through a touch screen, but also an input interface function for receiving the touch input of the user.

The memory 120 according to an embodiment of the present disclosure may be understood as a component including hardware and/or software for storing and managing data that is processed in the user terminal device 100. That is, the memory 120 may store any type of data generated or determined by the processor 130 and any type of data received by the user terminal device 100. For example, the memory 120 may include at least one type of storage medium selected from among flash memory, a hard disk, multimedia card micro-type memory, card-type memory, random access memory (RAM), static random access memory (SRAM), read-only memory (ROM), electrically erasable programmable read-only memory (EEPROM), programmable read-only memory (PROM), magnetic memory, a magnetic disk, and an optical disk. Furthermore, the memory 120 may include a database system that controls and manages data under a predetermined system. Since the types of memory 120 described above are only examples, the type of the memory 120 may be configured in various forms within a scope that can be understood by those skilled in the art based on the contents of the present disclosure.

The memory 120 may structure, organize and manage data required for the processor 130 to perform operations, combinations of data, and program codes executable by the processor 130. For example, the memory 120 may store program codes that calculate carbon emissions based on usage time and generate an UI and content based on the calculated carbon emissions, and processed data that is generated as the program codes are executed.

The processor 130 according to an embodiment of the present disclosure may be understood as a component including hardware and/or software for performing computing operations. For example, the processor 130 may read a computer program and perform data processing for machine learning. The processor 130 may process operational processes such as the processing of input data for machine learning, feature extraction for machine learning, and error calculation based on backpropagation. The processor 130 for performing such data processing may include a central processing unit (CPU), a general purpose graphics processing unit (GPGPU), a tensor processing unit (TPU), an application-specific integrated circuit (ASIC), a field programmable gate array (FPGA), etc. Since the types of processor 130 described above are only some examples, the type of processor 130 may be configured in various forms within a scope that can be understood by those skilled in the art based on the contents of the present disclosure.

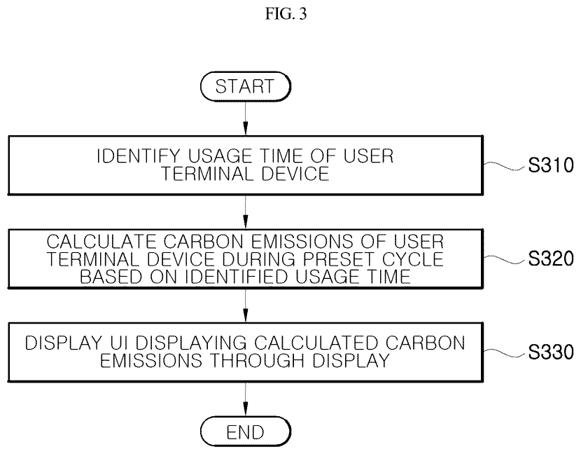

FIG. 3 is a flowchart schematically showing a method of controlling a user terminal device 100 for calculating carbon emissions based on usage time according to an embodiment of the present disclosure.

Referring to FIG. 3, the processor 130 identifies the usage time of the user terminal device 100 in step S310.

More specifically, the processor 130 may identify the usage time of the user terminal device 100 of the user for a preset period of time. In particular, the processor 130 may periodically identify the usage time of the user terminal device 100 of the user.

In this case, the usage time of the user terminal device 100 may be the usage time of an application that operates in conjunction with an external electronic device (i.e., the data center 200 or a server) among a plurality of applications (or a plurality of programs) installed on the user terminal device 100. In particular, the processor 130 may identify the cumulative time of the foreground execution of an application in which the application is displayed and executed on the display 110 of the user terminal device 100, other than the background execution of the application, as the usage time.

For example, the processor 130 may identify the usage time of the user terminal device 100 based on the usage analysis report of the user terminal device 100 that is generated periodically. The usage analysis report may be provided by the screen time function of Apple®, the digital wellbeing function of Google®, or the like.

In addition, the processor 130 may calculate the carbon emissions of the user terminal device 100 corresponding to the usage time during a preset cycle based on the identified usage time in step S320. As described above, as the user uses the user terminal device 100, the processor 130 may estimate and identify the carbon emissions of the user terminal device 100 by estimating the amount of carbon, emitted from the data center 200 in connection with the application executed on the user terminal device 100, as the carbon emissions of the user terminal device 100.

In this case, the processor 130 may calculate the carbon emissions of the user terminal device 100 in the same cycle as the usage analysis report of the user terminal device 100 is generated and provided, or may accumulate and add up the usage times of the user terminal device 100 of the user through the usage analysis reports of the user terminal device 100 provided periodically and then calculate the carbon emissions of the user terminal device 100 corresponding to the added usage time.

Meanwhile, the processor 130 may display a UI displaying the calculated carbon emissions through the display 110 in step S330.

More specifically, the processor 130 may display a UI and content related to carbon emissions through the display 110. In this case, the UI may include a graphics object representative of the carbon emissions, calculated in a previous cycle, together with the calculated carbon emissions, through which the user may check a change in carbon emissions attributable to the use of the user terminal device 100. In addition, the processor 130 may display a UI displaying various types of information such as reference carbon emissions and a carbon emission graph on the display 110.

Meanwhile, various types of information may be provided in the content related to carbon emissions. For example, challenge content, in which a plurality of users including the user share carbon emissions and compete to reduce the carbon emissions, may be provided.

Meanwhile, when the carbon emissions have increased compared to those in the previous cycle, the processor 130 may output a text or voice message or the like requesting the user to reduce carbon emissions.

Alternatively, the processor 130 may set reference carbon emissions for a subsequent cycle based on the calculated carbon emissions, or may set target carbon emissions based on the user's input. In this case, the processor 130 may manage or limit the use of the user terminal device 100 of the user when the usage time of the user terminal device 100 of the user exceeds the time corresponding to the reference carbon emissions or the calculated carbon emissions exceed the reference carbon emissions. For example, the processor 130 may limit the use of the user terminal device 100 of the user by adjusting the brightness of the display 110 or switching the mode of the user terminal device 100.

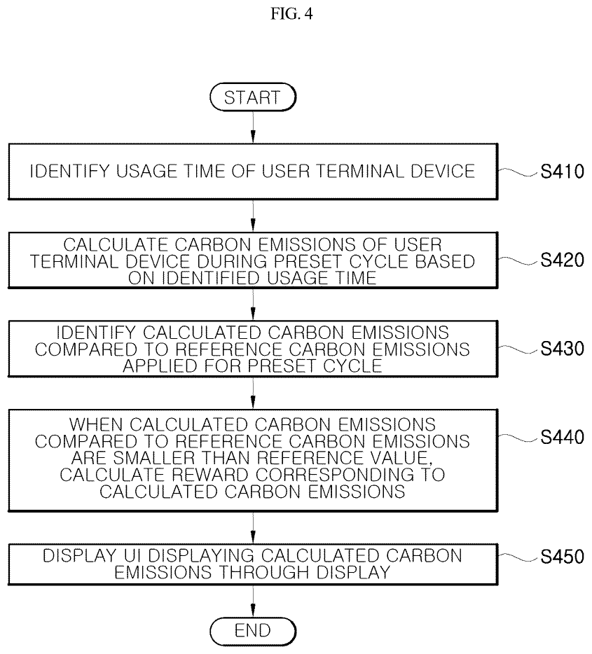

FIG. 4 is a flowchart showing a method of calculating carbon emissions compared to reference carbon emissions and then calculating a reward according to an embodiment of the present disclosure.

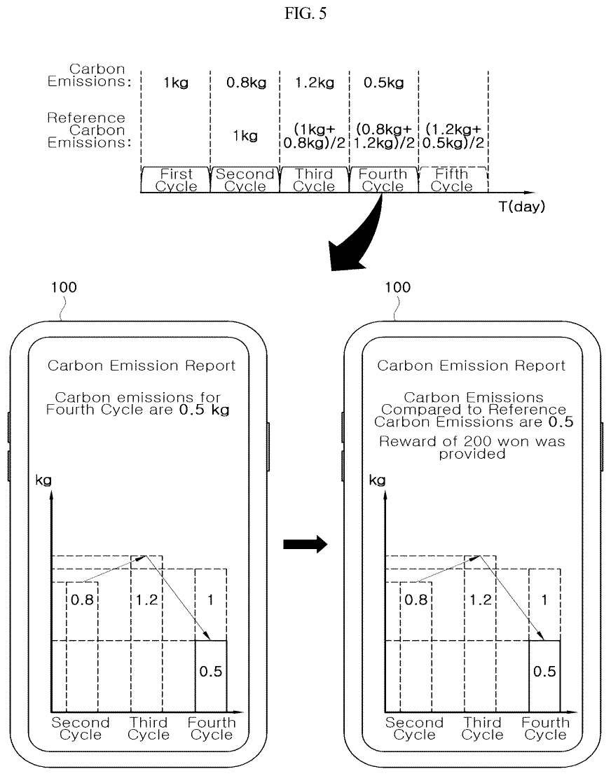

FIG. 5 is an exemplary diagram showing a method of setting reference carbon emissions according to an embodiment of the present disclosure and a method of calculating a reward based on carbon emission amounts compared to the reference carbon emissions. Since steps S410, S420, and S450 shown in FIG. 4 correspond to steps S310, S320, and S330 shown in FIG. 3, detailed descriptions thereof will be omitted.

According to an embodiment of the present disclosure, the processor 130 may identify the calculated carbon emissions compared to the reference carbon emissions applied during a preset cycle in step S430. The reference carbon emissions may be a value set to prompt the user to reduce the carbon emissions of the user terminal device 100. That is, the processor 130 sets reference carbon emissions and calculates the carbon emissions compared to the reference carbon emissions, thereby allowing the user to recognize how much carbon has been emitted compared to the reference carbon emissions, and ultimately, prompting the user to reduce carbon emissions attributable to the use of the user terminal device 100.

Meanwhile, the reference carbon emissions may be a fixed value, or may be maintained or updated according to the carbon emissions of each cycle.

Meanwhile, although the reference carbon emissions may be applied for a preset cycle, they may also be applied for a plurality of cycles. For example, the processor 130 may set reference carbon emissions for one week, may calculate carbon emissions every day, and may calculate cumulative carbon emissions and remaining carbon emissions based on the reference carbon emissions. However, for the convenience of description of the present disclosure, it is described below that the reference carbon emissions are applied and updated in the same cycle as the carbon emissions are calculated.

Meanwhile, when the calculated carbon emissions compared to the reference carbon emissions are smaller than a reference value, the processor 130 may calculate a reward corresponding to the calculated carbon emissions in step S440. More specifically, the processor 130 may determine whether the calculated carbon emissions compared to the reference carbon emissions are smaller than the reference value. In this case, the reference value may be set to a predetermined proportion of the reference carbon emissions. Furthermore, when it is determined that the calculated carbon emissions compared to the reference carbon emissions are smaller than the reference value, the processor 130 may calculate a reward corresponding to the calculated carbon emissions compared to the reference carbon emissions.

In contrast, when it is determined that the calculated carbon emissions compared to the reference carbon emissions are equal to or larger than the reference value, the processor 130 may restrict or manage the use of the user terminal device 100 during a subsequent cycle without calculating a reward. Since the foregoing description may be applied to this in the same manner, a detailed description thereof will be omitted.

As an example, the processor 130 may calculate a reward by multiplying a basic reward by the reciprocal of the calculated carbon emissions compared to the reference carbon emissions. More specifically, when the reference carbon emissions applied to a preset cycle (one week) are 1 kg, the carbon emissions calculated based on the usage time are 0.5 kg and the basic reward is 100 won, the processor 130 may calculate 200 won as a reward for the user's reduction in carbon emissions.

Meanwhile, the processor 130 may calculate the reward and then request the allocation of the reward from an external server that operates in conjunction with the user terminal device 100. The reward allocated to the user in this manner may be exchanged with another user, and the user may purchase an item on a platform by using the reward.

According to an embodiment of the present disclosure, the processor 130 may change the reference carbon emissions when the calculated carbon emissions compared to the reference carbon emissions are equal to or larger than the reference value. In particular, the processor 130 may apply reference carbon emissions (hereinafter referred to as “second reference carbon emissions”) having a smaller value than the reference carbon emissions applied to a previous cycle (hereinafter referred to as “first reference carbon emissions”) to a subsequent cycle. In contrast, the processor 130 may apply reference carbon emissions (hereinafter referred to as “third reference carbon emissions”) having a value equal to or larger than the first reference carbon emissions to the subsequent cycle when the calculated carbon emissions compared to the first reference carbon emissions are smaller than the reference value. In this case, the degree of change in the reference carbon emissions may be determined based on the calculated carbon emissions compared to the reference carbon emissions.

Referring to FIG. 5, as an example, the processor 130 may determine the carbon emissions to be applied to a subsequent cycle based on the carbon emissions calculated in a previous cycle. For example, the processor 130 may determine the average value of the carbon emissions, calculated in previous cycles, to be reference carbon emissions for a subsequent cycle. More specifically, in a third cycle, the average value of the carbon emissions of first and second cycles may be set as the reference carbon emissions, and, in a fourth cycle, the average value of the carbon emissions of second and third cycles may be set as the reference carbon emissions. In this case, the reference carbon emissions to be applied to a fifth cycle may vary depending on the carbon emissions calculated in the fourth cycle compared to the reference carbon emissions applied to the fourth cycle. In particular, when it is determined that the carbon emissions calculated compared to the reference carbon emissions are equal to or larger than a reference value, the processor 130 may determine the value, obtained by applying weights to the carbon emissions calculated in the third and fourth cycles, to be the reference carbon emissions to be applied to a fifth cycle. Meanwhile, in the case of the second cycle, the reference carbon emissions may be determined only based on the carbon emissions calculated in the first cycle.

Furthermore, unlike in the above-described example, the processor 130 may determine the carbon emissions calculated in a previous cycle (the third cycle in FIG. 5) to be the reference carbon emissions for a subsequent cycle (the fourth cycle in FIG. 5). The processor 130 may appropriately adjust the reference carbon emissions based on the carbon emissions calculated for each cycle.

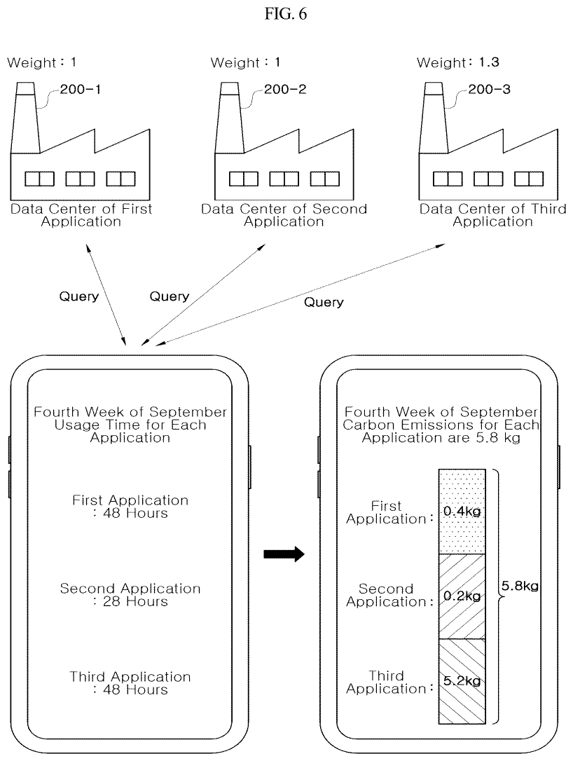

FIG. 6 is an exemplary diagram showing a method of calculating carbon emissions for each of a plurality of applications according to an embodiment of the present disclosure.

Meanwhile, according to an embodiment of the present disclosure, the processor 130 may identify the usage time of each of a plurality of applications installed in the user terminal device 100 during a preset cycle. Then, the processor 130 may calculate the total carbon emissions of the user terminal device 100 during the preset cycle and the carbon emissions attributable to the use of each of the plurality of applications based on the identified usage time of each of the plurality of applications. In this case, the processor 130 may display a UI displaying the carbon emissions attributable to the use of each application, together with the total carbon emissions, on the display 110.

More specifically, referring to FIG. 6, the processor 130 may accumulate and calculate the foreground execution time of a plurality of applications installed on the user terminal device 100 during a preset cycle. Then, the processor 130 may identify the calculated cumulative time for each of the applications as the usage time of each application, and may determine the carbon emissions attributable to the use of each application corresponding to the usage time of each application.

In this case, the processor 130 may calculate the carbon emissions attributable to the use of each application by applying the weight, calculated according to the environment of the data center 200-1, 200-2, or 200-3 corresponding to each application, to the usage time of each application.

As described above, the amount of carbon emitted from the data center 200-1, 200-2, or 200-3 of each application may vary depending on the environment of the data center 200-1, 200-2, or 200-3. That is, even when different applications are used for the same period of time, the carbon emissions from the individual data centers 200-1 to 200-3 may be different from each other. This is caused by differences between the environments of the data centers 200-1 to 200-3, such as data transmission paths based on data routing, the power supply methods of the data centers 200-1 to 200-3, the efficiencies of the cooling systems of the data centers 200-1 to 200-3, and/or the operation methods of the data centers 200-1 to 200-3. The processor 130 may calculate the carbon emissions attributable to the use of each application by determining the weight corresponding to each application with the environment of the data center 200-1, 200-2, or 200-3 of each application taken into consideration and then applying the determined weight to the usage time of each application. To this end, the memory 120 may store the environment information of the data center 200-1, 200-2, or 200-3 of each application and the weight information corresponding to each application. Referring to FIG. 5, the processor 130 may identify the carbon emission information for each application, may identify the environment of the data center 200-1, 200-2, or 200-3 of each application, and may calculate the weight corresponding to each application.

Referring to FIG. 6, although first and third applications are used for the same 48 hours during a week, the processor 130 may apply a weight of 1.3 to the usage time of the first application by taking into considering the environment of the data center 200-1, 200-2, or 200-3 of the first application, so that the carbon emissions attributable to the execution of the first and third applications may be calculated differently.

The weight applied to the usage time of each application may be obtained through a neural network model. The neural network model may be trained to output a weight corresponding to each application based on the number of queries transmitted to the data center 200-1, 200-2, or 200-3, the types of queries, and the environmental information of the data center 200 while each application is being executed. To this end, the neural network model may be trained in advance by using the number of queries transmitted during a preset time, the types of queries, and the environmental information of the data center 200 as learning data. As an example, the neural network model may be a multilayer perceptron (MLP), a convolutional neural network (CNN), a recurrent neural network (RNN), or the like.

Referring to FIG. 6, the processor 130 may display a UI displaying total carbon emissions and the ratio of carbon emissions for each application to the total carbon emissions on the display 110.

According to an embodiment of the present disclosure, the processor 130 may select a management application from among a plurality of applications based on the usage time of each of the plurality of applications, and may manage the use of the selected management application during a subsequent cycle.

As an example, the processor 130 may select an application, whose carbon emissions are equal to or larger than a reference value (a second reference value) or whose ratio of carbon emissions to total carbon emissions is equal to or larger than a reference ratio, as a management application. That is, the processor 130 may select an application, whose usage time is excessively long compared to other applications or whose carbon emissions calculated by taking into consideration the environment of the data center 200 are excessively large, as a management target (i.e., a management application). In this case, for the management application, the processor 130 may manage or limit the use of the management application of the user during a subsequent cycle. In particular, when a separate usage limitation time is set only for the management application and the usage limitation time is exceeded, the processor may prompt the user to reduce carbon emissions by stopping the execution of the management application or adjusting the brightness of the display 110.

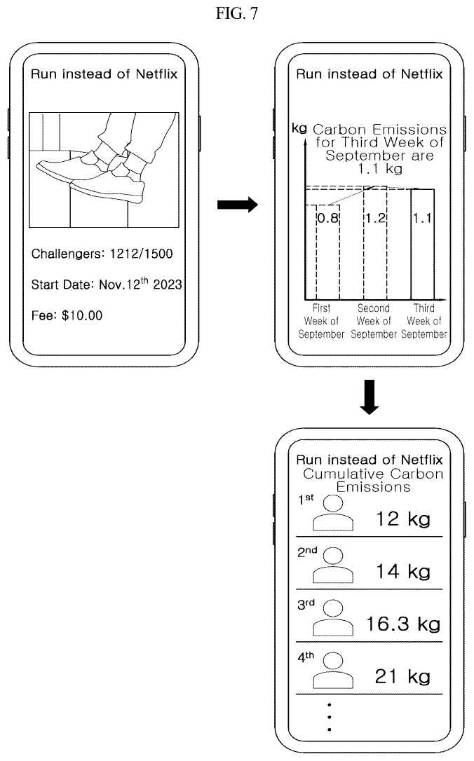

FIG. 7 is an exemplary diagram of challenge content for reducing carbon emissions according to an embodiment of the present disclosure.

According to an embodiment of the present disclosure, the processor 130 may generate challenge content for reducing the carbon emissions of a user terminal device 100 and share the generated challenge content with a plurality of other users through a communication interface in step 840.

The processor 130 may transmit information requesting the acceptance of the sharing of challenge content to a plurality of other users (i.e., the terminal devices of other users) registered in a server device (e.g., a platform server, or the like) that operates in conjunction with the user terminal device 100 after generating challenge content. Then, when the plurality of other users accept the sharing of the received challenge content, the processor 130 may share the generated challenge content with the user and the plurality of other users. In this case, the challenge content may be content that competes to emit less carbon for a preset period of time (hereinafter referred to as first challenge content). Meanwhile, the payment of a predetermined reward may be required for the generation of and a request for the first challenge content. Furthermore, the first challenge content may be intended to reduce the usage time for a specific application and reduce the amount of carbon generated by the execution of a specific application.

In this case, the processor 130 may identify the rankings of the user and the plurality of other users, who have shared the challenge content, for carbon emissions based on the calculated carbon emissions in each preset cycle, and may display the identified rankings through the display 110.

The processor 130 may determine the rankings for carbon emissions by aggregating the carbon emissions of a user and the carbon emissions of the plurality of other users calculated during the preset cycle. Furthermore, the processor 130 may update the rankings for carbon emissions in each preset cycle.

Meanwhile, the processor 130 may calculate a reward based on a final ranking for the carbon emissions of the user when a cycle set for the first challenge content ends. In particular, while the first challenge content is performed, the processor 130 may calculate a reward based on the calculated carbon emissions compared to the reference carbon emissions in each preset cycle, and may also calculate an additional reward based on the ranking of the first challenge content. Accordingly, the processor 130 may receive the calculated reward from the server device that operates in conjunction with the user terminal device 100.

Furthermore, according to an embodiment of the present disclosure, the processor 130 may generate another challenge content (hereinafter referred to as the “second challenge content”) for reducing the carbon emissions of the user terminal device 100, and may share the generated second challenge content with a plurality of other users through the communication interface 840. The second challenge content may be content in which a user forms a team along with a plurality of other users and competes with another team to reduce carbon emissions. In this case, the processor 130 may determine a plurality of other users to form a team along with the user according to the user's selection or randomly among a plurality of users who share the second challenge content.

In this case, the processor 130 may identify the carbon emissions of the plurality of users who share the generated second challenge content, may set reference carbon emissions for the plurality of users, and may select a user of interest from among the plurality of users based on the reference carbon emissions. That is, the processor 130 may set the same reference carbon emissions for the same team and may then select a user of interest within the team based on the reference carbon emissions and the calculated carbon emissions. In particular, the processor 130 may select a user having larger carbon emissions than other users as a user of interest.

In addition, the processor 130 determines the reference carbon emissions for the plurality of users during a subsequent cycle based on the carbon emissions of the plurality of users, but may apply reference carbon emissions different from the determined reference carbon emissions to the selected user of interest. That is, the processor 130 may apply smaller reference carbon emissions to the user of interest, thereby prompting the user of interest to emit less carbon than other users in the same team.

Meanwhile, it is obvious that the user may generate a plurality of pieces of challenge content and perform them simultaneously.

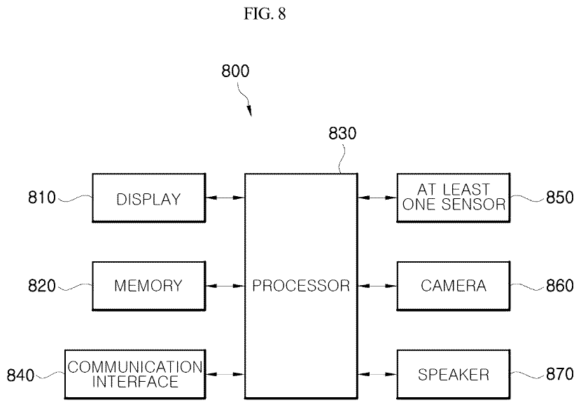

FIG. 8 is a block diagram showing the detailed configuration of a user terminal device 800 according to an embodiment of the present disclosure.

Referring to FIG. 8, the user terminal device 800 includes a display 810, memory 820, a communication interface 840, at least one sensor 850, a camera 860, a speaker 870, and at least one processor 830. Descriptions of the components shown in FIG. 8 that are the same as those shown in FIG. 2 will be omitted below.

The communication interface 840 is a component that allows the user terminal device 800 to perform communication with an external device, and the user terminal device 800 may transmit and receive various types of information through the communication interface 840. As an example, the user terminal device 800 may transmit challenge content information to another user through the communication interface 840, or may receive the environment information of the data centers 200 from the data centers 200 of a plurality of applications (or server devices). The communication interface 840 may perform data transmission and reception by using a wired/wireless communication system such as a local area network (LAN), a wideband code division multiple access (WCDMA) network, a long term evolution (LTE) network, the wireless broadband Internet (WiBro), a 5-th generation mobile communication (5G) network, an ultra-wideband network, a ZigBee network, a radio frequency (RF) communication network, a wireless LAN network, a wireless fidelity network, a near field communication (NFC) network, and/or a Bluetooth network. The above-described communication systems are only examples, and thus, the wired/wireless communication system for the data transmission and reception of the communication interface 840 may be applied in various formed in addition to the above-described examples.

The communication interface 840 may receive data, required for the processor 830 to perform operations, through wired/wireless communication with any system, any client, or the like. In addition, the communication interface 840 may transmit data, generated through the operations of the processor 830, through wired/wireless communication with any system, any client, or the like. For example, the communication interface 840 may receive medical data through communication with a database in a hospital environment, a cloud server for performing tasks such as the standardization of medical data, or a computing device. The communication interface 840 may transmit the output data of a neural network model, intermediate and processed data derived from the operation process of the processor 830, etc. through communication with the database, the server, or the computing device.

The at least one sensor 850 (hereinafter referred to as the “sensor 850”) may detect and acquire various types of information about the user terminal device 800 and the surroundings of the user terminal device 800. As an example, the sensor 850 includes a temperature sensor, and may detect changes in the temperature of the user terminal device 800 while an application is running and calculate a weight attributable to the changes in the temperature. Alternatively, the sensor 850 may be implemented as a time of flying (ToF) sensor, a lidar sensor, or the like and acquire information about an object surrounding the user terminal device 800.

The camera 860 photographs an object around the user terminal device 800 and acquires an image of the object. To this end, the camera 860 may be implemented as an image sensor such as a CMOS image sensor (CIS), a charge coupled device, or the like. However, the camera 860 is not limited thereto, but may be implemented as camera modules having various resolutions capable of photographing a subject. Meanwhile, the camera 860 may be implemented as a depth camera (e.g., an IR depth camera), a stereo camera, or an RGB camera.

The speaker 870 is a component that outputs various types of audio data that have been subjected to various processing operations such as decoding, amplification, and noise filtering by an audio processing unit (not shown). The speaker 870 may output various notification sounds or voice messages. According to an embodiment of the present disclosure, when the calculated carbon emissions compared to the reference carbon emissions are higher than the reference value, the user terminal device 800 may output a voice message, recommending the user to reduce the usage time of the user terminal device 800, through the speaker.

The various embodiments of the present disclosure described above may be combined with one or more additional embodiments, and may be changed within the range understandable to those skilled in the art in light of the above detailed description. The embodiments of the present disclosure should be understood as illustrative but not restrictive in all respects. For example, individual components described as unitary may be implemented in a distributed manner, and similarly, the components described as distributed may also be implemented in a combined form. Accordingly, all changes or modifications derived from the meanings and scopes of the claims of the present disclosure and their equivalents should be construed as being included in the scope of the present disclosure.

What is claimed is:

1. A method of controlling a user terminal device for calculating carbon emissions based on usage time, the method comprising:
identifying usage time of the user terminal device;
calculating carbon emissions of the user terminal device corresponding to the identified usage time during a preset cycle based on the identified usage time; and
displaying a user interface (UI) displaying the calculated carbon emissions through a display.

2. The method of claim 1, further comprising:
identifying the calculated carbon emissions compared to first reference carbon emissions applied during the preset cycle; and
when the calculated carbon emissions compared to the first reference carbon emissions are smaller than a reference value, calculating and providing a reward corresponding to the calculated carbon emissions.

3. The method of claim 2, further comprising, when the calculated carbon emissions compared to the first reference carbon emissions are equal to or larger than the reference value, applying second reference carbon emissions smaller than the first reference carbon emissions to a subsequent cycle.

4. The method of claim 1, wherein:
identifying comprises identifying usage time of each of a plurality of applications installed on the user terminal device during the preset cycle; and
calculating comprises calculating total carbon emissions of the user terminal device and carbon emissions attributable to use of each of the plurality of applications during the preset cycle based on the identified usage time of each application.

5. The method of claim 4, further comprising:
selecting a management application from among the plurality of applications based on the usage time of each of the plurality of applications; and
managing use of the selected management application during a subsequent cycle.

6. The method of claim 4, wherein calculating the total carbon emissions and the carbon emissions attributable to the use of each application comprises calculating the carbon emissions attributable to the use of each application by applying a weight, calculated according to an environment of a data center corresponding to each application, to the usage time of each application.

7. The method of claim 1, further comprising:
generating challenge content for reducing carbon emissions of the user terminal device; and
sharing the generated challenge content with a plurality of other users through a communication interface;
wherein displaying comprises identifying rankings of the user and the plurality of other users, who share the challenge content, for carbon emissions in the preset cycle based on the calculated carbon emissions, and displaying the identified rankings through the display.

8. The method of claim 7, further comprising, when the challenge content ends, calculating a reward based on a final ranking for the carbon emissions of the user.

9. The method of claim 1, further comprising:
generating challenge content for reducing carbon emissions of the user terminal device;
sharing the generated challenge content with a plurality of other users through a communication interface;
identifying carbon emissions of the plurality of users who share the generated challenge content, and setting reference carbon emissions for the plurality of users;
selecting a user of interest from among the plurality of users based on the reference carbon emissions; and
determining reference carbon emissions for the plurality of users for a subsequent cycle based on the carbon emissions of the plurality of users, and applying reference carbon emissions different from the determined reference carbon emissions to the selected user of interest.

10. A user terminal device for calculating carbon emissions based on usage time, the user terminal device comprising:
a display;
memory configured to store at least one instruction; and
at least one processor configured to, by executing the at least one instruction, identify usage time of the user terminal device during a preset cycle, calculate carbon emissions of the user terminal device during the preset cycle based on the identified usage time, and display a user interface (UI) corresponding to the calculated carbon emissions through the display.
